(19) United States
(12) Patent Application Publication
(10) Pub. No.: US 2012/0185208 A1
(43) Pub. Date: Jul. 19, 2012

(54) Method for detecting position and arrival time of accelerated particles and apparatus for carrying out said method

(75) Inventors: Borut BARICEVIC, Koper (SI); Peter OREL, Sezana (SI); Jure MENART, Medvode (SI); Rok URSIC, Nova Garcia (SI)

(73) Assignee: INSTRUMENTATION TECHNOLOGIES D.D., Solkan (SI)

(21) Appl. No.: 13/346,040

(22) Filed: Jan. 9, 2012

(30) Foreign Application Priority Data
Jan. 13, 2011 (SI) P-201100013

(51) Int. Cl. G06F 15/00

(52) U.S. Cl. 702/150

(57) ABSTRACT

The present invention refers to a method for detecting position and arrival time of accelerated particles, particularly in a linear particle accelerator, and to an apparatus for carrying out said method. When a correction is triggered, the apparatus according to the invention digitally processes a triggering signal by means of a programmable digital synthetic system being set in a manner that it is equivalent, referring to the time response, to the analogue correction signal received. The output from said synthetic system is deducted from the measurement, therefore, the correction signal is entirely deleted from the measurement. A special adaptive algorithm takes care for the time response compliance of the synthetic system with alterations in the analogue circuit generated due to the warming of the circuit itself.

### CROSS-REFERENCE TO RELATED APPLICATIONS

This application claims the benefit of priority from Slovenia patent application number SI P-201100013, filed Jan. 13, 2011.

### BACKGROUND OF THE INVENTION

1. Field of the Invention

The present invention refers to a method for detecting position and arrival time of accelerated particles, particularly in a linear particle accelerator, and to an apparatus for carrying out said method.

2. Description of the Related Art

Accelerating heavy particles requires a precise setting of the electromagnetic field in resonant cavities in the moment when particles cross said cavities. The arrival time of particles into the next resonant cavity is of the crucial importance, for said particles would receive incorrect energy dose if arrived at different time due to the time alteration of the field phase in said cavity. Due to accumulation of errors, the result is even greater deviation in the following cavities leading to the instability of the entire system. Due to said mutual influence between the resonant cavities and the particles, particle acceleration requires appropriate control of the resonant cavities and other accelerator parameters thus, resulting in an accurate detecting of the position and the travel time of the particles through sections.

Detecting the particles position and arrival time is carried out in different sections of the accelerator. Four electrodes are built into a vacuum tube of each section of the accelerator arranged in a plane of the cross-section of the vacuum tube. Thus, electrical signals in radio frequency range being excited on electrodes by particle bunches. Particle bunches sequences determine section-wise periodical pulse voltage patterns on the electrodes in which the signal strength is distributed particularly about certain harmonics of the base repeating frequency.

Usually, particles position and arrival time detection deals with an amplitude and phase detection of the excited frequency component on four electrodes. Detected amplitude differences between channels determine the particles position, and the phase offsets against the global reference signal determine the particles arrival time.

Typically, linear accelerators of heavy particles simultaneously supply different “experimental stations” with particles of different nature, thus acceleration is to be adapted to the current accelerated beam flavor. Beam flavors are typically changed up to 120 times per second. Said particles flavors determine the particle charge variation, and proportionally also amplitudes of the detected signal in wide ranges (even for a factor of 1000 and more). Generally, systems are used in the accelerators to detect particles position by means of which it is possible to handle detections in said amplitude ranges of the detected signal, however, a working area of the input power is to be set/switched in the detecting apparatus before the change of the signal input power takes place. Currently, detecting apparatuses having constant range of the operating power are in use with linear accelerators and within said specific applications such as detecting particles position and arrival time. When dealing with the low charge particles with such apparatuses, the signals on electrodes become very low and the noise of the receiver dominates over the signal, thus, it is not possible any more to determine the position and arrival time, respectively, within the required accuracy.

### SUMMARY OF THE INVENTION

It is the object of the present invention to create a method for detecting position and arrival time of accelerated particles, particularly in a linear particle accelerator, remedying thus drawbacks of the known solutions.

Further object of the invention is to create an apparatus for carrying out a method for detecting position and arrival time of accelerated particles, particularly in a linear particle accelerator.

The object as set above is solved by means of characteristics of the characterising portion of the claim 1.

### BRIEF DESCRIPTION OF THE DRAWINGS

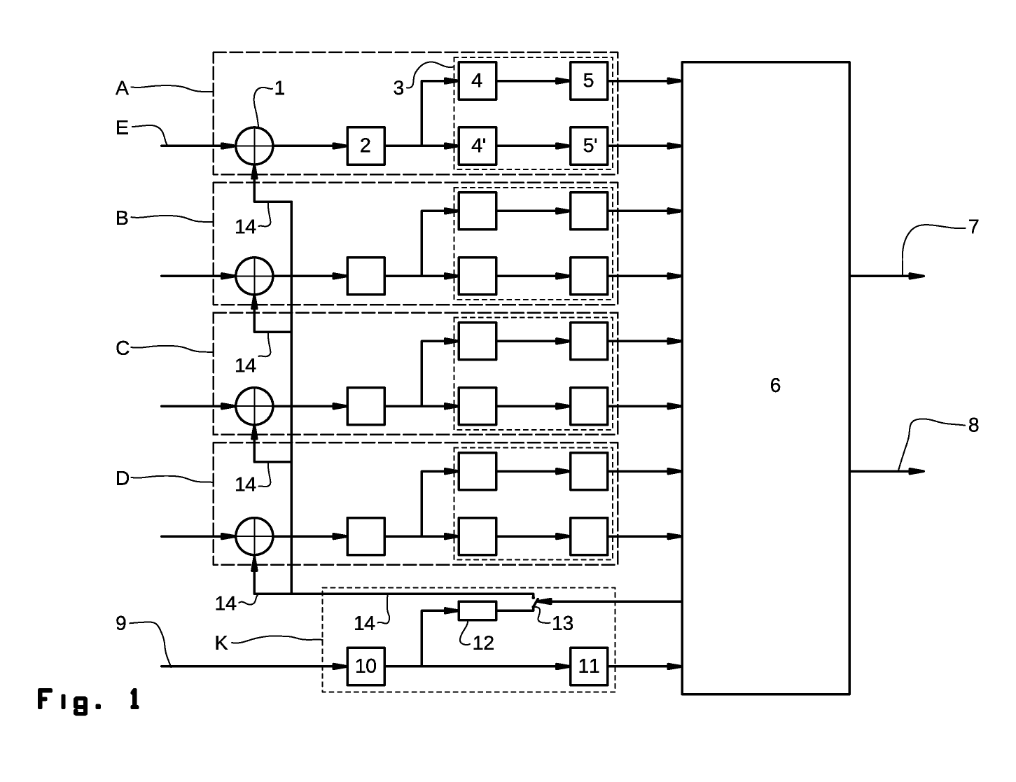

The invention is further described in detail on the basis of the preferred embodiment, and with a reference to the accompanying drawing, FIG. 1, where it is schematically shown an apparatus for detecting position and arrival time of accelerated particles, particularly in a linear particle accelerator, according to the invention.

### DETAILED DESCRIPTION OF EMBODIMENTS OF THE INVENTION

According to the present invention, an apparatus comprises a plurality of mutually parallel detecting channels, where the preferred embodiment shown in a drawing comprises a plurality of four detection channels A, B, C, D. Each said detection channel A, B, C, D comprises a summation block 1 receiving at the input thereof an analogue input signal E from each electrode of a linear accelerator not shown. An analogue processing unit 2 being connected downstream to said summation block 1 for preprocessing of said input signals E, said analogue processing unit 2 being preferably an analogue filter where said electrode input signal E arrives from each summation block 1. Furthermore, a processing unit 3 being connected downstream to said analogue processing unit 2, comprising a pair of mutually parallel processing chains each of which comprises a processing unit 4, 4′ and a digital converter 5, 5′ linked in series. As to the amplification and to the frequency response said processing chains 4, 5; 4′, 5′ are mutually completely independent. Afterwards, each signal from the analogue processing unit 2 for preprocessing said input signals E, is split into two mutually parallel parts, the first part of each said signal E enters the first processing chain 4, 5 of said processing unit 3, and the second part of each said signal E enters the second processing chain 4′, 5′ of said processing unit 3. In each said processing chain said signals being processed and transformed into digital form. A digital signal exiting each processing chain 4, 5; 4′, 5′ of said processing unit 3 being further directed into a programmable digital signal processing unit 6 the main goal thereof being detection of the amplitude and the phase of said digital signal. The first output 7 of said processing unit 6 represents now a result of a position detection, and the second output 8 of said processing unit 6 represents a result of time and phase detection, respectively.

In parallel with the four channels unit as described above, a correction chain K being attached to said processing unit by means of which an analogue reference sine signal 9 being directed into said processing unit 6 simultaneously with said digital signal. At first, said reference signal 9 being directed into an analogue processing unit in order to pre-process said reference signal 9, preferably in an analogue filter 10, and afterwards further into a digital converter 11 where said processed analogue reference signal 9 being digitized and forwarded into the processing unit 6. Prior entering said digital converter 11, a part of said reference signal 9 being split and directed into a processing unit 12 where being conveniently amplified and optionally used by means of an analogue non-linear transformation for generating harmonics of the input reference frequency which represent an analogue correction signal 14. In this manner, unwanted frequency contributions are filtered out, and the rest of said signal 14 enters into each said detecting channel A, B, C, D through fast radio-frequency switch 13 in very short programmable time periods via said summation block 1. When said switch 13 is closed, each processing unit 3 receives, in addition to said input signal E, also said correction signal 14. From the detected amplitude and phase of the correction signal 14 it can be measured the drift mutually introduced into processing units 3 due to printed circuit temperature changes. Drifts produced during longer time-spans can be measured through the digital signal processing, and, as a result, eliminated from the detecting apparatus. Thus, the apparatus with the correction according to the present invention, as described above, enables stable detection also of the slow variations of the beam position and the particles arrival time through the detecting section without the detection being distorted due to the temperature variations in the detecting apparatus.

Utilizing a proper setting of the analogue amplification makes possible to receive the input signal E even at the very low powers, since low signals are optimally amplified in a processing chain with a greater amplification. In contrast to the aforementioned, a processing chain with the lower amplification is useful with stronger input signals E. In the ultimate ranges of the input power, the system automatically selects digital data detection process on the basis of the current power of said input signal. With middle powers, the system carries out a weighted averaging from said processing chains 4, 5, 4′, 5′, thus reducing uncorrelated uncertainty introduced into each said processing chain. In addition, the system implements a digital response linearisation for the chain with greater amplification of the response of said processing chains, so that the integration of the information of said processing chain with the greater amplification is possible also with the relatively high power of the input signal.

Said extension of the input power range, and the detection improvement based on the two physically separated receivers enables a high-quality position detection and arrival time of the particles in a relatively broad spectre of the particle charge without necessity to change any analogue part of the system.

The system according to the present invention enables a parallel measurement of the amplitude and the phase also within several frequency components. In addition to the base frequency, the system deals in both the analogue and the digital process with harmonics of the base frequency of the repetition of the particle bunches. Each frequency component enables a detection of the particles position and arrival time of the comparable quality. The system carries out detections independently over each frequency component of the input signal in said channels, and deals with automatically for the final measurement of said apparatus to be optimally balanced average of each contribution, thus additionally diminishing the uncertainty of the final measurement.

Whenever the measuring phases are carried out on the harmonics of the base frequency, the system also carries out a transformation of the phase detection into the base frequency. Within said transformation, the apparatus according to the present invention provides for a solving the uncertainty due to the periodical phase with multiple frequency, and transmits the user of the apparatus an equivalent phase of the base frequency component.

With specific applications, where it is required a lower dynamics of the input power it is possible to set the amplification in said processing units 3 to similar values, and to offset accordingly the frequency response of each said processing unit, thus increasing the bandwidth of the transformed data for the factor of two, since the sampling of the common signal source in such a system is performed with a double density.

Said apparatus according to the present invention enables two types of sensing the correction signal. The first type is based on an interrupted operation, and the second type deals with an uninterrupted accelerator operation.

With the interrupted accelerator operation, it is possible to automatically trigger a correction signal 14 within certain time slots when no presence of the particles is declared. Thus, during the discrete time periods the apparatus carries out detections of the correction signal 14 and the signal E of the particle beam. Corrections, calculated on the basis of each detection of the correction signal 14 are used with the subsequent beam detection, for the temperature changes during very short time periods are rather negligible.

With the uninterrupted accelerator operation, the apparatus periodically engages the correction signal 14. The latter overlaps with the particles signal E, however, the apparatus records in the moment when the correction signal 14 has been introduced, average alterations in detection due to the contributions of the correction frequency components introduced. Since the apparatus itself triggers the correction, it is possible on the basis of the triggering delay detection of the correction signal and on the basis of the average recorded deviation to detect the contribution of the correction and to eliminate it entirely from the measurement.

When triggering the correction, the apparatus according to the present invention digitally process the triggering signal by means of a programmable digital synthetic system which is set in a manner that it is an equivalent, according to the time response, to the received analogue correction signal. The output of said synthetic system is subtracted from the measurement, thus the correction signal being entirely deleted from the measurement. A special adaptive algorithm being provided for the time response correction of the synthetic system with the perturbations in the analogue circuit, said perturbations being generated by the warming of the circuit itself.

1. A method for detecting position and arrival time of accelerated particles, particularly in a linear particle accelerator, characterised in that it comprises the following steps:
(a) sending an input signal (E) from a plurality of electrodes in an accelerator to the input of an analogue summation block (1) of each detection channel;
(b) preprocessing said input analogue signals (E) in an analogue processing unit (2) being connected downstream to said summation block (1);
(c) processing said input analogue signal (E) in a processing unit (3) being connected downstream to said analogue processing unit (2);
(d) splitting said analogue signal arriving from the analogue processing unit (2) into two mutually parallel parts, a first part of each said analogue signal entering a first processing chain (4, 5) of said processing unit (3), and a second part of each said analogue signal entering a second processing chain (4′, 5′) of said processing unit (3);
(e) processing and digitising said analogue signal in each processing chain (4, 5; 4′, 5′);
(f) supplying said digital signal into a programmable digital signal processing unit (6) for a detection of an amplitude and a phase of said digital signal;
(g) supplying analogue reference signal (9) being preprocessed in an analogue processing unit (10) and afterwards digitalised in a digital converter (11), to said processing unit (6) simultaneously with said digital signals arriving from said processing unit (3);
(h) supplying a part of said analogue reference signal (9) being preprocessed in said analogue processing unit (10), to a processing unit (12) for amplification and use, by means of an analogue non-linear transformation, to generate harmonics of an input reference frequency representing an analogue correction signal (14); and
(i) input said analogue correction signal (14) through a fast radio-frequency switch (13) into the summation block (1) of each detection channel.

2. A method according to claim 1, characterised in that said processing chains (4, 5; 4′, 5′) are mutually entirely independent concerning the amplification as well as to the frequency response.

3. A method according to claim 1, characterised in that said analogue processing unit (2, 10) is a filter.

4. An apparatus for detecting position and arrival time of accelerated particles, particularly in a linear particle accelerator, characterised in that comprises a plurality of detection channels (A, B, C, D) being mutually in parallel, each thereof comprising a summation block (1) to which an analogue processing unit (2) is connected downstream for preprocessing said input signal (E), that a processing unit (3) is connected downstream to said analogue processing unit (2), wherein a digital signal exiting said processing unit (3) being further directed into a programmable digital signal processing unit (6), and that a correction chain (K) being arranged in parallel with said detection channels.

5. An apparatus according to claim 4, characterised in that said correction chain (K) comprises a processing unit (10) for preprocessing a reference signal (9), a digital converter (11) being attached downstream thereto, which is linked with the processing unit (6), wherein between said processing unit (10) and said digital converter (11) there is arranged in parallel a processing unit (12) an analogue correction signal (14) exiting there from being directed via a fast radio-frequency switch 813) into said summation block (1) of each said detection channel (A, B, C, D).

6. An apparatus according to claim 4, characterised in that said processing unit (3₁, 3₂ . . . 3_{N}) comprises a pair of processing chains (4, 5; 4′, 5′) being mutually in parallel.

7. An apparatus according to claim 4, characterised in that said processing chain (4, 5; 4′, 5′) comprises an analogue processing unit (4, 4′) and a digital converter (5, 5′) connected downstream.

8. An apparatus according to claim 4, characterised in that said processing chains (4, 5; 4′, 5′) are mutually entirely independent concerning the amplification as well as to the frequency response.

9. An apparatus according to claim 4, characterised in that said analogue processing unit (2₁, 2₂ . . . 2_{N}; 10) is a filter.
